(19) United States
(12) Patent Application Publication
(10) Pub. No.: US 2011/0058890 A1
(43) Pub. Date: Mar. 10, 2011

(54) Tip for Ball Point Pen

(75) Inventor: Hak-Jae KIM, Daejeon City (KR)

(73) Assignee: Dong-A Pencil Co., Ltd., Seoul (KR)

(21) Appl. No.: 12/856,898

(22) Filed: Aug. 16, 2010

(30) Foreign Application Priority Data
Sep. 9, 2009 (KR) 10-2009-0084983

(51) Int. Cl. B43K 7/00

(52) U.S. Cl. 401/216

(57) ABSTRACT

Provided is a tip for a ball point pen that implements more comfortable writing by increasing the outflow amount of ink in writing.

A tip for a ball point pen of the present invention includes: a spherical ball; and a tip body having the front end formed in a conical shape, a ball house formed at the end of an ink outflow channel, and a ball support formed by making the front end portion narrower such that the ball is partially exposed and supported in the ball house, in which the external circumferential surface of the front end for forming the ball support of the tip body is formed at a taper angle of 3 to 10°.

### CROSS-REFERENCE TO RELATED APPLICATION

This application claims priority to and the benefit of Korean Patent Application No. 10-2009-0084983 filed in the Korean Intellectual Property Office on Sep. 9, 2009, the entire contents of which are incorporated herein by reference.

### BACKGROUND OF THE INVENTION

(a) Field of the Invention

The present invention relates to a tip for a ball point pen. More particularly, the present invention relates to a tip for a ball point pen that makes it possible to increase the outflow amount of ink and implement more comfortable writing by smoothly forming the external circumferential surface of the end where a ball support is formed.

(b) Description of the Related Art

In general, ball point pens are writing materials that write in a way of smearing ink on a ball rotated by friction with a writing surface, such as paper, and transferring the ink on the paper, and have a tip for the ball point pen.

As shown in FIG. 1 and FIG. 2, a tip 1 for a ball point pen is composed of a tip body 2 and a ball 10 positioned at the front end of the tip body 2, in which the tip body 2 has an ink outflow channel 3 and a ball house 4 retaining the ball 10 to be partially exposed, at the end of the ink outflow channel 3.

The front end portion of the tip body 2 of the tip 1 for a ball point pen is formed in a conical shape with an external circumferential slope 5 at about 30 to 60°. A ball support 6 that supports the ball is formed by spinning or caulking to make the front end narrower, with the ball 10 in the ball house 4.

According to the tip 1 for a ball point pen, as the ball 10 is moved backward by pressure applied in writing, the gap between the ball 10 and the ball support 6 is made wider, such that ink flows out.

However, in the tip 1 for a ball point pen of the related art, the height ‘h’ of the exposed portion of the ball 10 and convenience of manufacturing are considered in priority in making the ball support 6 in the tip body 2; however, outflow performance of the ink is generally not considered.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a tip for a ball point pen having advantages of making it possible to implement more comfortable writing by making the external circumferential slope smooth to form a ball support and effectively increasing the outflow amount of ink with the increase of a ball displacement.

An exemplary embodiment of the present invention provides a tip for a ball point pen, which includes: a spherical ball; and a tip body having the front end formed in a conical shape, a ball house formed at the end of an ink outflow channel, and a ball support formed by making the front end portion narrower such that the ball is partially exposed and supported in the ball house.

The external circumferential surface for forming the ball support of the tip body is formed at a taper angle of 3 to 10°.

According to the exemplary embodiment of the present invention, it is possible to increase the outflow amount of ink discharged through between the ball and the inner side of the ball support in writing, because the front-rear displacement of the ball increases after the ball support is formed, when the external circumferential surface of the tip body is formed at a predetermined range of a taper angle to form the ball support.

Therefore, it is possible to implement more comfortable writing while achieving smooth writing, as compared with the related art.

Further, according to the exemplary embodiment of the present invention, since the gap between the ball and the inner side of the ball support increases in writing, it is possible to reduce the amount of ink that does not flow into the ball support and collects outside.

Therefore, it is possible to prevent a writing line, a writing surface, and hands etc from being stained with the collecting ink, and it is also possible to write and keep the pen while keeping it clean.

### BRIEF DESCRIPTION OF THE DRAWINGS

FIG. 1 is a front view showing a tip for a ball point pen of the related art;

FIG. 2 is an enlarged cross-sectional view showing the tip for a ball point pen of the related art;

FIG. 3 is an enlarged cross-sectional view showing when a ball support is not formed yet in a tip for a ball point pen according to an exemplary embodiment of the present invention; and

FIG. 4 is an enlarged cross-sectional view showing when a ball support is formed in the tip for a ball point pen according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown.

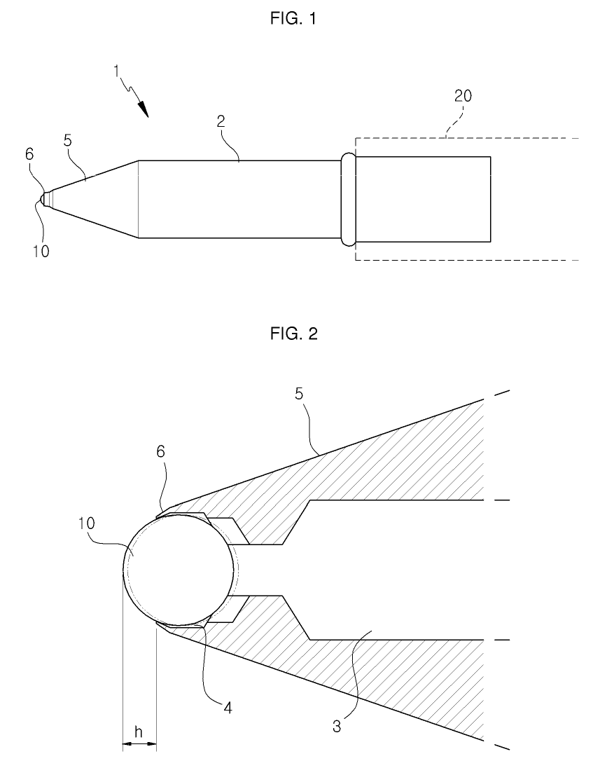

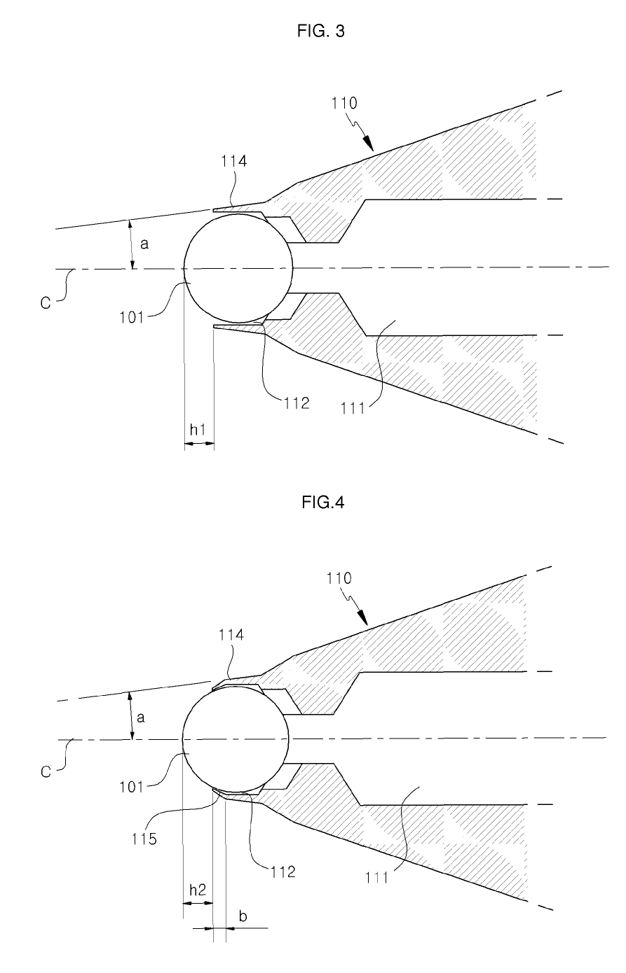

First, a tip for a ball point pen according to an exemplary embodiment of the present invention, as shown in FIGS. 1 to 3, includes a ball 101 and a tip body 110 with the ball 101 at the front end.

The ball 101 is a sphere having a predetermined diameter.

The diameter of the ball 101 may be about 0.3 to 1.2 mm.

The front end portion of the tip body 110 is formed in a conical shape and the rear end portion is assembled with an ink storage pipe 20.

An ink outflow channel 111 is formed through the tip body 110 along the center axis line C to supply the ink stored in the ink storage pipe 20 to the ball 101.

A ball house 112 retaining the ball 101 is formed at the front end portion of the ink outflow channel 111 of the tip body 110.

The ball 101 is retained, with a portion exposed, in the ball house 112.

A ball support 115 is formed by spinning (or caulking) at the front end portion 114 of the tip body 110.

The front end portion 114 for forming the ball support 115 has an external diameter gradually increasing toward the rear such that the angle ‘a’ (hereafter, referred to as a “taper angle”) made by the external circumferential slope and the center axis line C is about 3 to 10°.

That is, the external circumferential surface of the front end portion 114 has a taper angle ‘a’ of about 3 to 10° before the ball support 115 is formed.

The following Table 1 shows an experiment result for examining changes in the amount of ink Q (hereafter, referred to as ‘ink outflow amount) discharged through between the ball 101 and the inner side of the ball support 115 in writing in accordance with the taper angle ‘a’ of the front end portion 114, which measured the front-rear displacement ‘d’ of the ball 101 and the ink outflow amount Q while changing the taper angle ‘a’ and the spinning width ‘b’ and maintaining the ball height h1 before the ball support 115 is formed and the ball height h2 after the ball support 115 is formed.

The ball 101 was 0.7 mm and the tip body 110 was 0.7 mm hybrid test 14, and the ink was JSRB 2, and spinning is performed to the ball support 115 at 2520 rpm.

TABLE 1

| | Condition | | | | Result | |
|---|---|---|---|---|---|---|
| Order | a(°) | h1 (mm) | h2 (mm) | B (mm) | D (mm) | Q (mg/100M) |
| 1 | 17 | 0.235 | 0.215 | 0.230 | 0.010 | 20 |
| 2 | 15 | 0.235 | 0.215 | 0.200 | 0.010 | 24 |
| 3 | 12 | 0.235 | 0.215 | 0.166 | 0.012 | 28 |
| 4 | 9 | 0.235 | 0.215 | 0.143 | 0.014 | 32 |
| 5 | 6 | 0.235 | 0.215 | 0.126 | 0.016 | 38 |
| 6 | 3 | 0.235 | 0.215 | 0.113 | 0.018 | 42 |
| 7 | 0 | 0.235 | 0.215 | 0.104 | 0.020 | 48 |

As can be seen from Table 1, it was shown that the larger the taper angle ‘a’, the more the front-rear displacement ‘d’ of the ball 101 and the ink outflow amount Q substantially decrease, whereas the smaller the taper angle ‘a’ the more the front-rear displacement ‘d’ of the ball 101 and the ink outflow amount Q increase.

Meanwhile, it is difficult to perform spinning to the front end portion of the tip body 110, when the taper angle ‘a’ is small, below 3°, while the front-rear displacement ‘d’ of the ball 101 does not increase, when the taper angle ‘a’ is substantially above 10°; therefore, it would be preferable not to select these cases.

While the present invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A tip for a ball point pen, comprising:
a spherical ball; and
a tip body having the front end formed in a conical shape, a ball house formed at the end of an ink outflow channel, and a ball support formed by making the front end portion narrower such that the ball is partially exposed and supported in the ball house,
wherein the external circumferential surface of the front end for forming the ball support of the tip body is formed at a taper angle of 3 to 10°.
